(19) United States
(12) Patent Application Publication
(10) Pub. No.: US 2026/0219484 A1
(43) Pub. Date: Jul. 30, 2026

(54) SURGICAL MICROSCOPES USING RED REFLEX ILLUMINATION

(71) Applicant: Horizon Surgical Systems, Inc., Malibu, CA (US)

(72) Inventors: Al-Hafeez DHALLA, Durham, NC (US); Andrew MURNAN, Saratoga Springs, NY (US)

(21) Appl. No.: 19/146,202

(22) PCT Filed: Jan. 5, 2024
(86) PCT No.: PCT/US2024/010536

§ 371 Date: Jul. 7, 2025

Related U.S. Application Data
(60) Provisional application No. 63/478,813, filed on Jan. 6, 2023.

(51) Int. Cl. G02B 21/00; G02B 21/06

(52) U.S. Cl. CPC G02B 21/0012; G02B 21/06

(57) ABSTRACT

Devices, methods, and systems related to surgical microscopes using red reflex illumination are provided. According to one aspect of the present invention, there is a red reflex surgical microscope system which may have: a red reflex illumination source, an objective lens, and an aperture stop. In certain embodiments, the aperture stop is located between the illumination source and objective lens. An image of the aperture stop may be imaged in proximity to the objective lens, and a size of beams reflected from the objective lens are shortened based on the proximity of the image of the aperture stop to the objective lens. Other embodiments described herein include a red reflex surgical microscope system used in conjunction with an OCT and coupled via a dichroic mirror, with an obstruction configured to minimize glare by being positioned on or adjacent to a side of the dichroic mirror not reflecting OCT light. Other embodiments include an oblique white-light illumination source. Yet other embodiments are described herein.

### CLAIM OF PRIORITY

This application claims priority to U.S. Provisional Application No. 63/478,813, titled “SURGICAL MICROSCOPES USING RED REFLEX ILLUMINATION,” filed Jan. 6, 2023, the contents of which is incorporated herein by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

Aspects of the present invention relate to surgical microscopes and, more particularly, to ophthalmic surgical microscopes using red reflex illumination.

### BACKGROUND

Ophthalmic surgical microscopes require bright and uniform illumination of the surgical field in general, and more particularly, illumination that can provide even illumination of the pupil of the eye from light that is backscattered from the retina. This backscattered light from the retina takes on a reddish-orange tint and is referred to as red reflex. The brightness and uniformity of the red reflex depends on coaxial illumination, with the observation beam path within a few degrees of the illumination path. It is known in the art that perfectly coaxial illumination (i.e., 0° to the observation beam path) will produce the highest quality red reflex in terms of brightness and uniformity. However, during cataract surgery, after the lens is removed and small pieces of the broken apart lens remain, visualization of those residual pieces is vital for their removal to avoid complications from the surgery. To best visualize those pieces, some edge definition is required, and it has been shown that using red reflex illumination that is a couple of degrees off from the observation beam path (i.e., not perfectly coaxial) produces better contrast of these structures.

Other devices known in the art use a beam pickoff of the general internal illumination for their red reflex illumination where white light illumination is entered near the outside edge and just above the objective and a series of mirrors outside of the observation beam path deflect a portion of that white light illumination to make it near coaxial with the observation beam path. However, this is not as conveniently possible once optical coherence tomography (OCT) is introduced above the objective. Intraoperative OCT guided surgery helps to determine tissue planes and optimal lens positioning. It is possible to introduce OCT below the objective, but a dichroic beam splitter below the objective reduces the operating room under the objective, referred to as working distance. In addition, the optical quality of the observation beam is reduced when the dichroic beam splitter is introduced below the objective. Other devices known in the art have introduced OCT above the objective in collimated space, but either the OCT has been so small as to have a very low numerical aperture (NA) or a large OCT beam requires sufficient space between the objective and observation optics that glare from red reflex or internal oblique white light illumination for the surgical field can interfere with imaging performance.

In addition, the beam deflection mirrors used in some art is not dynamic, but rather will only snap to two locations to avoid the observation beam path, and thus perfectly coaxial illumination (i.e., with an angle of 0° to the observation beam path) is not possible. While there are some devices known in the art that are dynamic with their beam deflection illumination, these can create shadows in the general illumination surgical field.

Furthermore, the optical system for the red reflex is typically fixed and will have an adjustable aperture to control the size of the red reflex at the pupil of the eye. This is not an efficient use of light, particularly for small fields of view (FOVs). In instances where it is desirable to stop down the red reflex illumination, prior art systems will typically need to reduce the size of the red reflex aperture stop (it if is adjustable at all), discarding a large fraction of the available light.

It is worth noting that typical red reflex illumination uses a white light source where the green and blue light is absorbed by the retina and necessitates a limiting factor to the brightness of the red reflex illumination to avoid retinal damage, and that power is generally wasted since it does not effectively contribute to the red reflex backscattered light.

What is needed are systems and methods for reducing red reflex in image guide systems combining microscopy with OCT.

### SUMMARY OF THE DISCLOSURE

According to one example of the present invention, there is a red reflex surgical microscope system, including: a red reflex illumination source, an objective lens, and an aperture stop, in which the aperture stop is located between the illumination source and objective lens, in which an image of the aperture stop is imaged in proximity to the objective lens, in which a size of beams reflected from the objective lens are shortened based on the proximity of the image of the aperture stop to the objective lens.

According to one embodiment of this example, the imaging system is fixed.

According to one embodiment of this example, the imaging system is a continuously adjustable zoom system, in which the continuously adjustable zoom system adjusts a magnification of the beam reflected from the objective lens.

According to one embodiment of this example, the size of beams reflected from the objective lens is adjusted by adjusting one or more of a plurality of: (i) a group of lenses, (ii) prisms, and (iii) mirrors.

According to one embodiment of this example, the group of lenses are one or more of positive and negative lenses, in which the lenses are adjusted from a nominal position to a maximum position away from the objective lens.

According to one embodiment of this example, the red reflex illumination source illuminates at wavelengths corresponding to a reddish-orange spectrum, in which the red reflex illumination source includes one or more of an LED and a broadband light source, in which the surgical microscope system includes one or more of: a surgical microscope configured for cataract surgery, a stereo microscope, and a multi-channel microscope.

According to one embodiment of this example, a size of a beam from the red reflex illumination source at an object plane is varied via the aperture stop adjusting a beam magnification, in which a fixed amount of optical power used by the illumination source allows for a higher irradiance at the objective lens.

According to yet another example of the present invention, there is a red reflux surgical microscope system, including: a red reflex illumination system, having: a red reflex illumination source, an objective lens, and an aperture stop; an optical coherence tomography (OCT) system; and an obstruction; in which the red reflex illumination system and the OCT system are coupled via a dichroic mirror, in which the red reflux surgical microscope system is configured to minimize glare from the objective lens via positioning the obstruction on or adjacent to the dichroic mirror.

According to one embodiment of this example, a back reflection occurs from the bottom surface of the objective lens.

According to one embodiment of this example, there is a dichroic beam splitter positioned below the objective lens, in which the OCT is also positioned below the objective lens, in which the beam splitter is configured to reduce an operating space (“working distance”) under the objective lens.

According to one embodiment of this example, there is an antireflective (AR) coating configured to reduce glare is used on one or more of the objective lens and dichroic mirror, in which the AR coating is configured to be optimized for performance in the orange-red region of the visible spectrum.

According to yet another example, there is an oblique white-light surgical microscope system, including: a white-light illumination system, having: a white-light illumination source, an objective lens, and an aperture stop; an optical coherence tomography (OCT) system; and an obstruction; in which the white-light illumination system and the OCT system are coupled via a dichroic mirror, in which the oblique white-light surgical microscope system is configured to minimize glare and back scatter from the objective lens via positioning the obstruction on or adjacent to a side of the dichroic mirror not reflecting OCT light.

According to one embodiment of this example, the white-light illumination system is configured to eliminate glare from the white-light illumination source via angling luminaries towards a center of the objective lens.

According to one embodiment of this example, there are a plurality of oblique illuminators located outside of the white-light illumination system.

According to yet another example of the present invention, there is a method for red reflex illumination of a surgical field of vision, including: emitting red reflex light from a light source through an illumination path aimed at an objective, setting an observation beam path substantially coaxial to the illumination path; implementing an optical zoom and fixed aperture stop in the observation beam path to image a red reflex aperture stop near the objective to produce a minimum beam diameter under collimated light; and preventing transmission of backscattered light through the observation beam path.

According to one embodiment of the method, the emitting step emits red reflect light in a reddish-orange illumination wavelength.

According to one embodiment of the method, the reddish-orange illumination is within the range of 590 nm-750 nm.

According to one embodiment of the method, the setting step further comprises producing an improved visualization contrast of the illumination path by varying the illumination path by more than 0 degrees and up to 6 degrees from the observation beam path.

According to one embodiment of the method, the optical zoom from the implementing step includes positive and negative lenses for magnification.

According to one embodiment of the method, the preventing transmission of backscattered light step is performed by placing an obstruction adjacent to a non-OCT reflective surface of a dichroic mirror.

According to one embodiment of the method, white light is emitted from the light source, in which glare from the white light is eliminated via positioning the light source at a minimum oblique angle to the objective.

### BRIEF DESCRIPTION OF THE DRAWINGS

FIG. 1 depicts an isometric view of the illuminating device according to aspects of the present invention.

FIG. 2 illustrates a side view of the illuminating device.

FIGS. 3A and 3B show an example of the zoom system in its nominal and alternative configuration.

FIG. 4 depicts an exemplary source spectrum.

FIGS. 5A and 5B illustrate a nominal and alternative mode of operation of illumination in one specific embodiment.

FIGS. 6A and 6B depict an alternative embodiment of red reflex illumination.

FIGS. 7A and 7B show the peak illuminance with nominal and an alternative source size.

FIG. 8 shows one mode of glare control in a specific embodiment.

FIG. 9 illustrates a side view of glare control with some mechanical components in one specific embodiment.

### DETAILED DESCRIPTION

The various aspects of the present invention aim to improve upon the above limitations when introducing a wide-field and a relatively large NA OCT scanning beam above the objective.

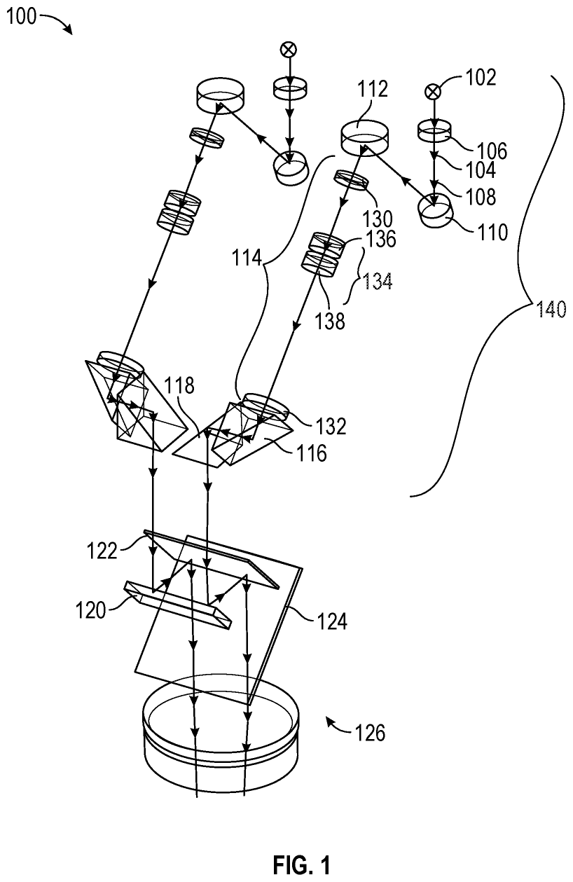

With the use of an optical zoom system for the red reflex 100 (see FIG. 1), aspects of the invention can overcome some previous mentioned limitations. The use of an optical zoom 114 for the red reflex alters the relationship of power used by the light source and FOV. Rather than employing an adjustable aperture stop, a fixed aperture stop 108 may be used in conjunction with an optical zoom system 114. This allows for an efficient use of red reflex light, particularly for small FOVs. It allows for a higher irradiance at the object plane for the same amount of optical power. This may lead to improved transmission for the observation beam path by biasing the red reflex beam splitter 122, which is described in more detail below.

In addition, the use of a zoom optical system 114 following the aperture stop 108, which also images the red reflex aperture stop 108 near the objective 126, minimizes the back reflections that become possible with a large space between the objective 126 and observation optics to allow for a large dichroic beam splitter 122 between. When rays of light are near the center of the objective 126, as light that diverges from common white light in red reflex optical systems with beam deflection mirrors that are nearly coaxial with the observation beam path, there is a greater chance of glare that enters the observation beam path. Imaging the aperture stop 108 for the red reflex to the objective 126 allows for the smallest beam diameter possible and still use collimated light, thereby minimizing troublesome back reflections from imperfect anti-reflective (AR) coatings on the optics.

To further minimize glare, it was discovered that placing a properly sized obstruction at or above the back side of the dichroic mirror 124 (the side that does not reflect OCT light) allows clear paths for the observation beams yet completely blocks the potential for back scattered light from certain surfaces of the objective that would otherwise be transmitted through the observation beam path and detected thereby causing offensive glare.

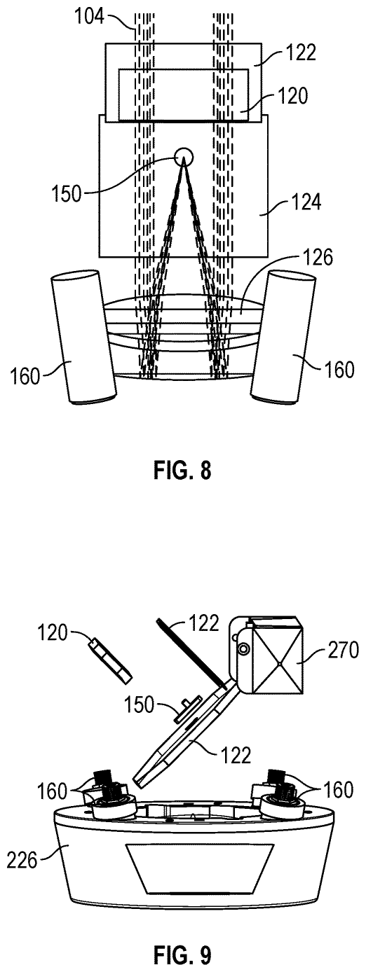

Furthermore, to eliminate glare from oblique white light illumination for the surgical field in such a system 100, the luminaries 160 (see FIGS. 8-9) are positioned external as minimally as possible to the objective to keep the oblique angle as small as reasonably possible, which allows for a smaller objective, but has the tradeoff of having oblique illumination that is greater than the traditional 6°.

Lastly with regards to glare management and optical efficiency, the use of a red reflex light that has limited bandwidth from a LED in the reddish-orange range allows the use of higher performance AR coatings for the red reflex optical elements thereby reducing the intensity of backscattered light from those elements. According to certain examples, the reddish-orange range of the visible spectrum may be in the range of 590 nm-750 nm (orange range 590 nm-620 nm and red range 620 nm-750 nm). In addition, by not wasting optical power in the blue-green region that is absorbed and not returned from the retina in sufficient optical power, we create a more efficient overall red reflex illumination system 100 and as mentioned above, could improve transmission by the beam splitter described in further detail below. The use of reddish-orange illumination wavelengths also improves patient safety, by precluding photochemical hazards associated with blue and green wavelengths.

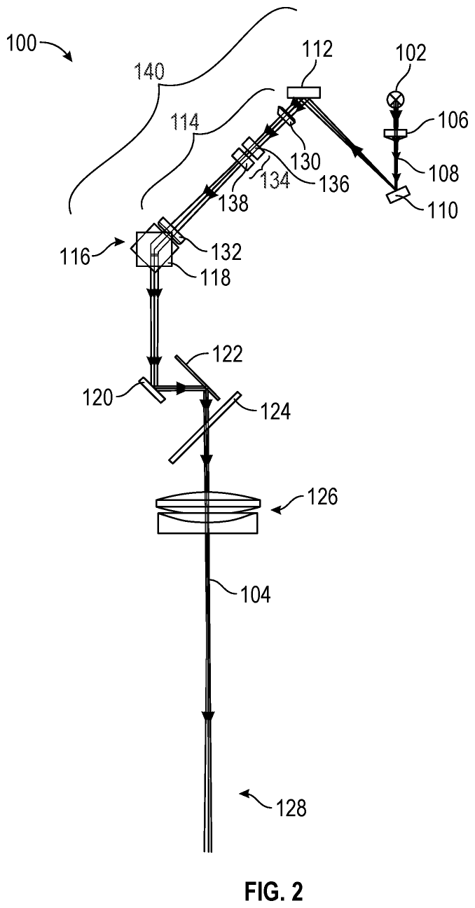

FIGS. 1, 2, 3A, 3B, 5A, 5B, 6A, 6B, 8, and 9 each show various views of the device in specific embodiments and are described in further detail below. FIGS. 1 and 2 show an isometric view and front view, respectively, of the illumination beam paths through a specific embodiment of the device. The following left and right illumination paths of light are now discussed separately but are symmetrical to one another. A light source 102, which may be a substantially uniform source of light from a large core multimode fiber (not shown) or other source with spatial uniformity, has light rays beam path 104 guided by the optical system 100 that comprises collimation lens 106, an aperture stop 108, fold mirrors 110 and 112, optical zoom system 114, deflecting prisms 116 and 118, a fold mirror 120, beam splitter 122, dichroic mirror 124, main objective 126 and imaged to object plane 128 (see FIG. 2). The optical zoom system 114 comprises positive lenses 130 and 132, and a negative lens group 134, where the negative lenses consist of identical negative lenses 136 and 138. The upper red reflex optical train from light source 102 through deflecting prism 118 is labeled upper red reflex 140. All the lenses in this optical zoom system may be configured in alternative embodiments to achieve a desired zoom range and aberration correction. According to certain examples, a digital or analog microscope may be used. Similarly, the magnification of the red reflex system may be affected by various magnification and zoom mechanisms.

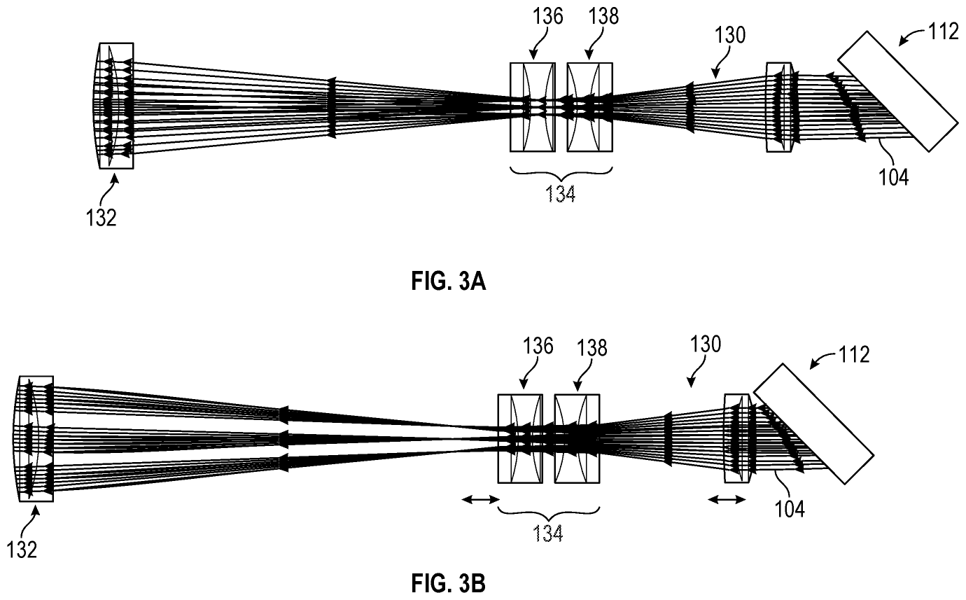

This critical illumination with zoom system 114 allows for efficient use of optical power and adjustment of the size of the red reflex illumination at the object plane 128, which may be the pupil of an eye (not shown). This illumination is continuously adjustable by an overall optical system 100 magnification of 6× to 12× by positioning negative lens group 134 and positive lens 130 while positive lens 132 remains fixed. The side view shown in FIGS. 3A and 3B show the adjustment range of optical zoom system 114 in this specific embodiment. Negative lens group 134 may be adjusted from its nominal position, which achieves an overall 6× magnification for optical system 100, to a maximum position of 9.7 mm further away from fixed lens 132. Positive lens 130 may be adjusted from its nominal position to a maximum position of 5.8 mm further away from fixed lens 132. Both adjustments together will achieve a 12× overall optical system 100 magnification for the red reflex illumination.

The beam splitter 122, as shown in FIGS. 1 and 2 has a transmission to reflection ratio of 80% to 20%. However, any ratio may be used with suitable beam splitter 122 optical coatings depending on the brightness of light source 102 and sensitivity and efficiency of the observation beam imaging system (not shown).

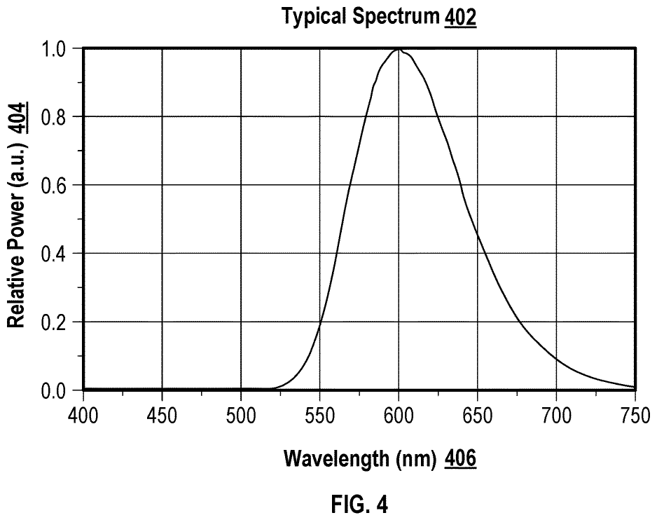

FIG. 4 depicts the spectrum 402 of light source 102 of FIGS. 1 and 2. Light source 102 is an LED (not shown) injected into a multimode fiber (not shown) with its bandwidth selected for the orange and red range. In alternative embodiments, additional filters may be used to further limit the LED bandwidth. When this spectrally limited bandwidth source 102 is used, it becomes a more efficient use of optical power 404 when back scattered from the retina. This contrasts with white light illumination that would otherwise have its blue and green wavelengths 406 absorbed by the retina and wasted in terms of the brightness of the red reflex illumination that is backscattered towards the observation beam path.

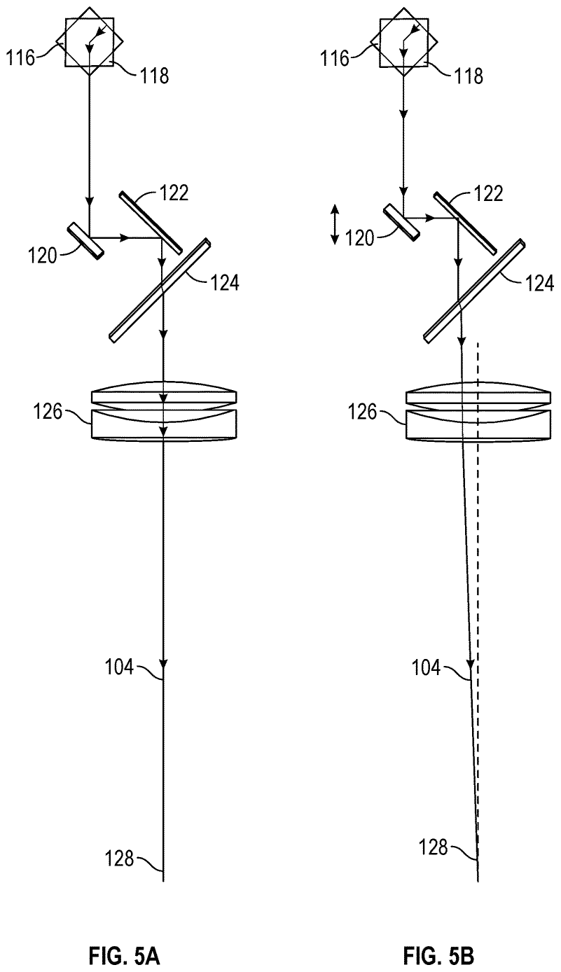

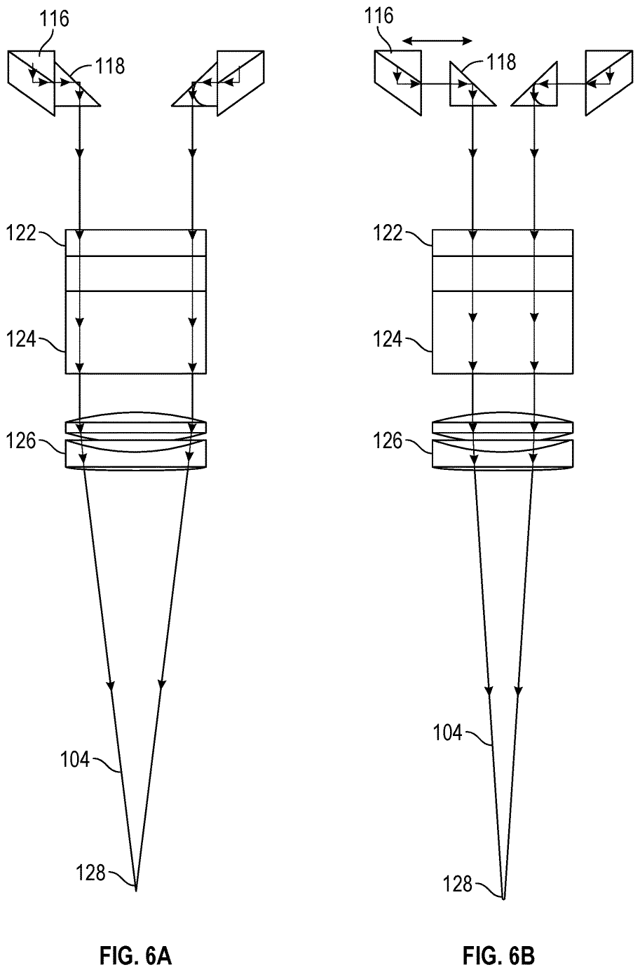

As depicted in FIGS. 5A and 5B, fold mirror 120 is continuously adjustable vertically to achieve a substantially coaxial beam, relative to the observation beam path, between 0° and +2° to allow for the excellent red reflex contrast and red reflex brightness. In this embodiment, fold mirror 120 is adjusted up to 7 mm from its nominal 0° coaxial red reflex illumination position. FIG. 5B shows this angle of the beam 104 relative to the optical axis 190 of the main objective 126. In an alternative embodiment, as shown in FIGS. 6A and 6B, the beam paths and all optical elements from the light source 102 through deflecting prism 118 may be more widely spaced. This allows for the side-to-side continuous adjustment of deflecting prism 118 to achieve an even greater range of coaxial angles from 0° up to a maximum of 3.6° from the observation beam path using the same smaller Ø 60 mm objective 126. With larger objectives, larger coaxial angles may be safely used up to a reasonable 6° coaxial angle using a Ø 74 mm with a 200 mm focal length objective. As the light 104 is collimated following fixed lens 132 (see FIG. 1), the imaging quality at object plane 128 is unchanged and the greater range of angles allows for more exploration tradeoffs between red reflex brightness and edge contrast of small residual objects.

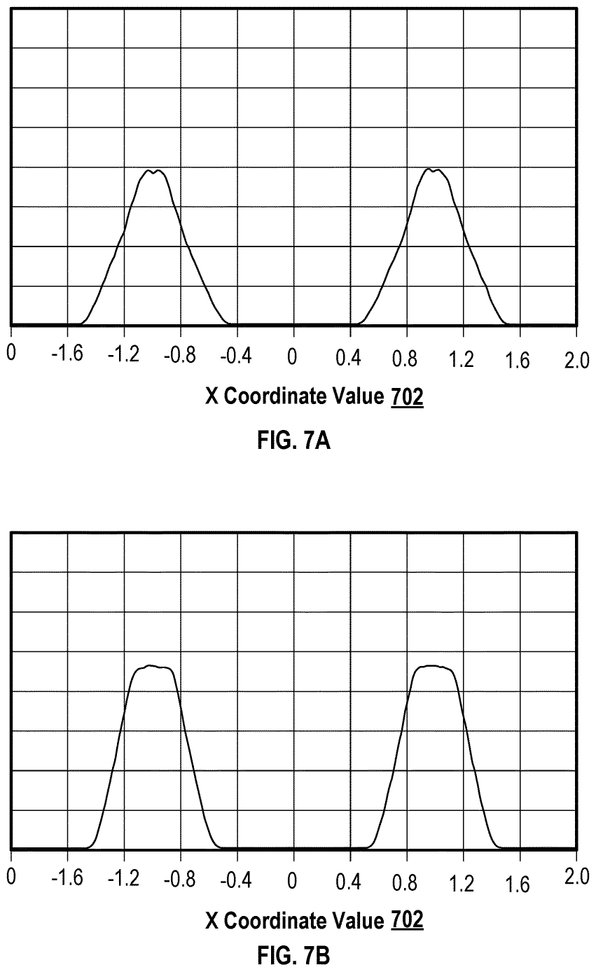

FIG. 7A shows exemplary spot sizes on a typical retina when light source 102 of FIG. 1 has a diameter substantially near 1 mm and is 0° coaxially located to the observation beam path. However, smaller source sizes may still be safe for the retina as the source size is not the main driver in of irradiance at retina with this style of illumination, but rather the imaging NA and position of the source relative to back focal plane of the main objective 126 (from FIG. 1). In an alternative embodiment, a light source diameter of 0.6 mm would have a spot profile as shown in FIG. 7B. While the peak irradiance is approximately 17% higher than with the Ø 1 mm light source 102, the overall shape of the irradiance is different, but not any more harmful than a 1 mm light source diameter. This gives rise to the discussion that using critical illumination is simpler than using typical Kohler illumination and not a detriment in terms of optical quality due to the source uniformity, shape, and size. Higher optical magnifications with the red reflex zoom system allows for even higher peak irradiance.

Related to FIG. 2 but not yet discussed, the red reflex illumination system 100 was designed to minimize potential glare from main objective 126. Due to the large gap between main objective 126 and imaging system (not shown), which allows room for an exemplary large-sized optical coherence tomography scanning beam (OCT beam not shown) to enter the optical system 100 above the main objective 126 from the right and reflect down from dichroic mirror 124 towards objective plane 128, glare can more easily occur from red reflex illumination than it can in a surgical microscope that does not have a large dichroic mirror above the main objective. To mitigate the glare, an obstruction 150 is carefully sized and positioned above and near or on the dichroic, as shown in FIG. 8, where an objectionable back reflection occurs from the bottom surface of objective 126. This allows for no vignetting of the observation beam but minimizes glare that could make its way directly through the observation beam imaging system (not shown) and does not interfere with the OCT optical system (not shown).

In another aspect of this red reflex illumination system 100 to minimize glare, not previously discussed, the aperture stop 108 is imaged near the main objective 126 as shown in FIG. 2 to minimize the size of the rays reflecting from the various surfaces of the main objective. It is very difficult to minimize glare when rays 104 become too close to the center portion of main objective 126. If the aperture stop were not imaged substantially near the objective, the rays would be spread out at the objective, thereby greatly increasing the risk of glare transmitting thought the observation beam path imaging system.

Lastly, as shown in FIGS. 8 and 9, the four external and oblique white light general illumination luminaries 160 were brought outside the main objective 126/226 and angled toward the center of object plane 128. This eliminates the risk of glare from any white light source and allows for a smaller and less expensive main objective 126/226. To further mitigate the chance of scatter, FIG. 9 shows beam dump 270 is positioned to capture any collimated light that is reflected from fold mirror 120 and transmitted through beam splitter 122. An advantage of the use of the oblique white-light general illumination external to the objective and not part of the red reflex illumination system 100, and with the use of reddish-orange red reflex illumination light, higher performance anti-reflective (AR) coatings with a minimum reflection near the orange and red wavelengths may be used for all transmissive optical elements as part of the red reflex illumination system 100 for further reduction in potential glare.

While desiring not to be bound by theory, it is believed that the inventive optical system embodiments described herein provide at least four advantages over conventional optical systems. First, the incorporation of a zoom system in the red reflux path via imaging the source into the pupil or other optical target. This approach severs the relationship between total red reflex beam power and illuminated field of view (FOV) at the pupil that is typical of the more standard constant irradiance approaches. As a result, the inventive system is more power efficient, particularly for small FOVs. As a result of this efficiency, the system allows the use of lower power sources, alone or in combination with more efficient light collection from the patient eye, achieved by biasing the beam splitter to favor the collection path. Second, there is the advantageous optimization of using “red” wavelengths for red reflex illumination. In itself, this approach has the advantage of not exposing the patient's retina to blue and green wavelengths that do not contribute significantly to the red reflex, and pose potential photochemical hazards to the retina. In addition, this aspect combined with the zoom system more completely embraces the use of “red” wavelengths since this combination better confines the light to stay within the pupil. Such a combination reduces or eliminates tinting the rest of the anterior chamber with red light. In contrast, such a scheme implemented with a conventional aperture approach would result in a system that would be highly inefficient when stopped down. A third advantage is provided by the incorporation of red reflex adjustable angle. While desirous to have angle optimization to be not quite co-axial, the manner of achieving this desired orientation is not provided in conventional systems. Embodiments of the inventive system provide component arrangements that enable making the angular adjustment dynamic as well as the possibility of producing a purely coaxial illumination operation. Additionally or optionally, there may also be provided improvements for a dynamically adjustable implementation. A fourth improvement arises from the implementation of improved glare management. In some embodiments of the improved illumination system there is combined one or more of the techniques of: (1) the obscuration on the dichroic, (2) moving the oblique illuminators out of the microscope and (3) using higher performance coatings over the narrower bandwidth of the red illumination.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of any aspects of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of embodiments of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of embodiments of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of embodiments of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single aspect of an invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A red reflex surgical microscope system, comprising:
a red reflex illumination source,
an objective lens, and
an aperture stop, wherein the aperture stop is located between the illumination source and
objective lens, wherein an image of the aperture stop is imaged in proximity to the objective lens, wherein a size of beams reflected from the objective lens are shortened based on the proximity of the image of the aperture stop to the objective lens.

2. The system of claim 1, wherein the imaging system is fixed.

3. The system of claim 1, wherein the imaging system is a continuously adjustable zoom system, wherein the continuously adjustable zoom system adjusts a magnification of the beams reflected from the objective lens.

4. The system of claim 1, wherein the size of beams reflected from the objective lens is adjusted by adjusting one or more of a plurality of: (i) a group of lenses, (ii) prisms, and (iii) mirrors.

5. The system of claim 4, wherein the group of lenses are one or more of positive and negative lenses, wherein the lenses are adjusted from a nominal position to a maximum position away from the objective lens.

6. The system of claim 1, wherein the red reflex illumination source illuminates at wavelengths corresponding to a reddish-orange spectrum, wherein the red reflex illumination source includes one or more of an LED and a broadband light source, wherein the surgical microscope system includes one or more of: a surgical microscope configured for cataract surgery, a stereo microscope, and a multi-channel microscope.

7. The system of claim 1, wherein a size of a beam from the red reflex illumination source at an object plane is varied via the aperture stop adjusting a beam magnification, wherein a fixed amount of optical power used by the illumination source allows for a higher irradiance at the objective lens.

8. A red reflux surgical microscope system, comprising:
a red reflex illumination system, comprising:
a red reflex illumination source,
an objective lens, and
an aperture stop;
an optical coherence tomography (OCT) system; and
an obstruction; wherein the red reflex illumination system and the OCT system are coupled via a dichroic mirror, wherein the red reflux surgical microscope system is configured to minimize glare from the objective lens via positioning the obstruction on or adjacent to the dichroic mirror.

9. The microscope system of claim 8, wherein a back reflection occurs from the bottom surface of the objective lens.

10. The microscope system of claim 8, further comprising a dichroic beam splitter positioned below the objective lens, wherein the OCT is also positioned below the objective lens, wherein the beam splitter is configured to reduce an operating space (“working distance”) under the objective lens.

11. The microscope system of claim 8, wherein antireflective (AR) coating configured to reduce glare is used on one or more of the objective lens and dichroic mirror, wherein the AR coating is configured to be optimized for performance in the orange-red region of the visible spectrum.

12. An oblique white-light surgical microscope system, comprising:
a white-light illumination system, comprising:
a white-light illumination source,
an objective lens, and
an aperture stop;
an optical coherence tomography (OCT) system; and
an obstruction; wherein the white-light illumination system and the OCT system are coupled via a dichroic mirror, wherein the oblique white-light surgical microscope system is configured to minimize glare and back scatter from the objective lens via positioning the obstruction on or adjacent to a side of the dichroic mirror not reflecting OCT light.

13. The oblique white-light surgical microscope system of claim 12, wherein the white-light illumination system is configured to eliminate glare from the white-light illumination source via angling luminaries towards a center of the objective lens.

14. The oblique white-light surgical microscope system of claim 12, further comprising a plurality of oblique illuminators located outside of the white-light illumination system.

15. A method for red reflex illumination of a surgical field of vision, comprising:
emitting red reflex light from a light source through an illumination path aimed at an objective,
setting an observation beam path substantially coaxial to the illumination path;
implementing an optical zoom and fixed aperture stop in the observation beam path to image a red reflex aperture stop near the objective to produce a minimum beam diameter under collimated light; and
preventing transmission of backscattered light through the observation beam path.

16. The method of claim 15, wherein the emitting step emits red reflect light in a reddish-orange illumination wavelength.

17. The method of claim 16, wherein the reddish-orange illumination is within the range of 590 nm-750 nm.

18. The method of claim 15, wherein the setting step further comprises producing an improved visualization contrast of the illumination path by varying the illumination path by more than 0 degrees and up to 6 degrees from the observation beam path.

19. The method of claim 15, wherein the optical zoom from the implementing step includes positive and negative lenses for magnification.

20. The method of claim 15, wherein the preventing transmission of backscattered light step is performed by placing an obstruction adjacent to a non-OCT reflective surface of a dichroic mirror.

21. The method of claim 15, wherein white light is emitted from the light source, wherein glare from the white light is eliminated via positioning the light source at a minimum oblique angle to the objective.
